(19) United States
(12) Patent Application Publication
(10) Pub. No.: US 2009/0169275 A1
(43) Pub. Date: Jul. 2, 2009

(54) TRANSFER MEMBER IN IMAGE FORMING APPARATUS AND IMAGE FORMING APPARATUS

(75) Inventors: Takeshi Watanabe, Kanagawa (JP); Minoru Yoshida, Tokyo (JP); Masashi Takahashi, Kanagawa (JP); Mitsuaki Kouyama, Tokyo (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/337,025

(22) Filed: Dec. 17, 2008

Related U.S. Application Data
(60) Provisional application No. 61/016,734, filed on Dec. 26, 2007.

(51) Int. Cl. G03G 15/01

(52) U.S. Cl. 399/302

(57) ABSTRACT

The transfer member in an image forming apparatus according to an embodiment of the invention is a transfer member in an image forming apparatus for transferring a toner image obtained by developing an electrostatic latent image formed on an image carrier onto a material to be transferred, wherein the transfer member includes a base material having thereon a surface layer for temporarily holding on the surface thereof the toner image to be transferred onto the material to be transferred and comprising a resin containing a diamond fine particle in the range of from about 0.01% to about 40%.

### CROSS-REFERENCE TO RELATED APPLICATION

This application is based upon and claims the benefit of priority from U.S. Provisional Application No. 61/016,734, filed Dec. 26, 2007, the entire content of which is incorporated herein by reference.

### TECHNICAL FIELD

The present invention relates to a transfer belt in an image forming apparatus by an electrophotographic system and to an image forming apparatus using the same.

### BACKGROUND

In general, cleaning means is required in intermediate transfer bodies such as an intermediate transfer belt of an image forming apparatus by an electrophotographic system or transfer means by a transfer body such as a transfer belt. Though a blade is effective as the cleaning means, friction is large so that a fluorocarbon resin layer is often formed on the surface of the transfer belt. However, by providing a fluorocarbon resin, not only the costs are high, but also sufficient abrasion resistance cannot be secured. Thus, when used repeatedly, the fluorocarbon resin layer was shaven in due course, and hence, the transfer belt had to be periodically exchanged.

In contrast, there is known a countermeasure for devising to realize a long life by dispersing a particle of alumina or the like as a reinforcing agent of the fluorocarbon resin layer. However, when such a relatively large filler is separated, it acts itself as an abrasive. Thus, there was the case where the opposite effect is rather brought.

Also, in an intermediate transfer belt, when the belt is an elastic body, it is known that hollow defects are hardly generated at the time of transfer and that secondary transfer characteristics onto rough paper having rough surface properties are excellent.

The hollow defects as referred to herein refer to a phenomenon in which in transferring a thin-line image, the interior of the thin line remains without being transferred and is easily generated when the intermediate transfer belt is made of a rigid material such as a resin. Though a belt having elasticity on the surface thereof is advantageous on this point, elastic bodies such as rubber are poor in mold release properties and large in friction so that there is a problem in cleaning properties. As a result of taking into these circumstances, it is generally carried out to provide a surface layer of a fluorocarbon resin or the like on the elastic layer.

Here, if the surface layer of a fluorocarbon resin or the like can be coated thin, it is possible to sufficiently obtain the effect of the elastic layer. However, when thinly coated, the durability is impaired so that it was difficult to make both the effect of the elastic layer and the durability compatible with each other.

Furthermore, since the fluorocarbon resin itself has high resistance, when thickly coated, the charge remains on the surface of the transfer belt to cause charge-up, and the image quality is easily adversely affected in repeated use. Furthermore, resistance unevenness is easily generated. In particular, when a thin surface layer is formed, transfer unevenness is generated, or abnormal local discharge or the like is easily generated due to influences of the resistance unevenness. Thus, there was encountered a problem that transfer dusts and so on are generated.

On the other hand, in recent years, attention is paid to a diamond fine particle which is called nano-diamond as a reinforcing agent of the resin layer. When the diamond fine particle is dispersed, the abrasion resistance is remarkably enhanced. Similarly, diamond-like carbon (DLC) has abrasion resistance of nine times that of fluorine.

In particular, so far as it is concerned with an electrophotographic apparatus, an example wherein DLC is used as a fixing measure is disclosed in JP-A-2005-183122. According to this JP-A-2005-183122, it is described that energy-saving fixation was realized by using DLC for a surface release layer on an elastic layer of a fixing roller or the like and regulating a membrane thickness to not more than 5 μm.

In order to prevent gloss unevenness, it is important that the surface of the fixing roller copes with the roughness of paper, and it is effective to provide an elastic layer. However, since mold release properties are required for the surface, a surface layer comprising fluorine, etc. was provided so far. However, in view of the problem of abrasion resistance, it is difficult to make the surface layer thin. Therefore, the performance was brought to some extent while compromising with both gloss unevenness and durability by making the elastic layer thick.

However, for the purpose of achieving energy saving, it is important to reduce the heat capacity of the fixing roller, and it is desirable that the elastic layer is thin. Here, when the surface layer is thin, even if the elastic layer is thin, follow-up properties to paper can be secured. In this way, it is devised to cope with durability using DLC for the surface layer.

On the other hand, JP-A-10-18037 describes that for the purpose of enhancing the durability, DLC is applicable to a surface layer for a transfer belt.

That is, in the fixation-related citation (JP-A-2005-183122 as cited above), DLC is applied because it is desirable to make the surface layer thin while keeping the high durability, whereas in the transfer-related citation (JP-A-10-18037 as cited above) DLC is applied to the surface of a transfer belt for the purpose of enhancing the durability of the belt. The both make the best use of durability of diamond.

Here, the problems of the conventional intermediate transfer belt and transfer belt technologies are put in order as follows.

(1) The abrasion resistance of the transfer belt or intermediate transfer belt is not sufficient.
(2) In order to prevent defect of transferred colorant or the like, even if an elastic layer is provided on the belt, when cleaning properties and durability are taken into consideration, the surface layer is a resin layer. When the surface layer is thick, an effect of the elastic layer is impaired so that it is difficult to realize a high image quality.
(3) The resin of the surface layer, such as a fluorocarbon resin, is high in resistance, and when thickly formed, deterioration in image quality due to charge-up on the belt surface is easily generated. Also, even when thinly formed, transfer unevenness due to resistance unevenness or transfer dusts due to local discharge or the like is easily generated. Also, in order to reduce the electrical resistance, even when a filler such as carbon is dispersed, there is a defect in dispersibility or the like, and transfer unevenness due to resistance unevenness is easily generated.

Here, as to the abrasion resistance which is the foregoing problem (1), it can be easily supposed that as described in the above-cited patent documents, the abrasion resistance can be improved by forming a DLC membrane on the surface layer. In the above-cited patent documents, only DLC is disclosed relative to the transfer belt, but a diamond fine particle or a particle size thereof or the like is not disclosed at all.

### SUMMARY

According to one viewpoint of the invention, there is provided a transfer member in an image forming apparatus for transferring a toner image obtained by developing an electrostatic latent image formed on an image carrier onto a material to be transferred, wherein the transfer member includes a base material having thereon a surface layer for temporarily holding on the surface thereof the toner image to be transferred onto the material to be transferred and comprising a resin containing a diamond fine particle in the range of from about 0.01% to about 40%.

The invention is to solve all of the foregoing problems by using DLC or a diamond fine particle for a surface layer of an intermediate transfer belt or a transfer belt. In particular, a DLC membrane is liable to become high in manufacturing costs by a CVD method or the like, whereas the diamond fine particle can be used upon being dispersed in a resin, etc., it can be easily manufactured at low costs, and it may be said that the diamond fine particle is excellent on this point.

According to the invention, though a fluorocarbon resin layer is used for a surface layer of a transfer belt or an intermediate transfer belt, by dispersing, as a reinforcing agent, a diamond fine particle which is called nano-diamond and which has a particle size of not more than 300 nm (more preferably not more than 100 nm), not only the abrasion resistance and lubricity are enhanced, but the transfer performance (image quality) is improved. As to the diamond fine particle itself, the majority thereof is insulating. However, those which are conductive are also included depending upon impurities and a crystal structure, and the electrical resistance of the surface layer can be regulated.

Also, for the purpose of controlling the conductivity, when a publicly known filler (for example, a conductive carbon black, a titanium oxide fine particle, etc.) is simultaneously dispersed, it becomes easy to regulate the resistance of the surface layer. Furthermore, by using the diamond fine particle, it is possible to reduce transfer unevenness of the resistance as the surface layer as compared with the existing fluorocarbon resin or the case of dispersing a filler in a fluorocarbon resin.

Also, in an elastic layer-provided intermediate transfer belt, by dispersing a diamond fine particle in the surface layer, even in a thinner surface layer, the durability can be kept. Thus, it becomes possible to achieve transfer with a high image quality onto even high-durability paper with rough irregularities. Also, as the surface layer can be made thin, it is advantageous in superimposition and transfer in the color image formation as compared with an insulating surface layer which is thickly formed by a fluorocarbon resin or the like because charge-up on the belt surface can be suppressed even in a state that the resistance of the surface layer is high (substantially insulating), whereby a high image quality can be realized.

As described previously, by using a diamond fine particle-dispersed surface layer of the invention, even when the surface layer is made thin, the surface layer is hardly shaven. Therefore, it is possible to realize high durability. At the same time, since the surface layer can be thinly formed, it is easy to follow up the elongation of a rubber base material, and a crack is hardly generated.

Also, the diamond particle may be directly dispersed in an elastic layer itself (for example, a urethane rubber or a silicon rubber). In that case, there are exhibited more excellent effects such that the fluorocarbon layer is not necessary whereby the transfer belt and the intermediate transfer belt can be manufactured at a low cost and that low friction and abrasion resistance at the same time without impairing the elasticity.

Also, by forming a DLC (diamond-like carbon) layer by a CVD method or the like but not the diamond fine particle as the surface layer, effects of the same tendency as that described above can be obtained. Though DLC involves a disadvantage that it is expensive, in the DLC membrane, it is also possible to impart the conductivity and to regulate the electrical resistance by doping boron or the like.

Of these effects of the diamond or DLC coat, as to those of high durability and low friction, for example, even an application to the surface of a rib on the back face of the belt is able to contribute to realization of high image quality and high durability in a different sense.

By using the diamond fine particle-dispersed surface layer of the invention, even when the surface layer is made thin, the surface layer is hardly shaven. Therefore, it is possible to realize high durability. At the same time, since the surface layer can be thinly formed, it is easy to follow up the elongation of a rubber base material, and a crack is hardly generated.

### DESCRIPTION OF THE DRAWINGS

FIG. 1 is a diagrammatic view showing an imaging forming unit of a monochromic image forming apparatus in an embodiment of the invention.

FIG. 2 is a diagrammatic view showing an image forming unit of a color image forming apparatus of a quadruple tandem system of intermediate transfer in an embodiment of the invention.

FIG. 3A is a cross-sectional view showing a structure of a transfer belt of an embodiment of the invention.

FIG. 3B is a cross-sectional view showing a structure of an intermediate transfer belt of an embodiment of the invention.

FIG. 4A is a view showing a structure in which a rib is provided in an end of an intermediate transfer belt, and a guide groove is provided in a conveyance roller.

FIG. 4B is a view showing a structure in which the rib is inserted into the guide groove in the structure shown in FIG. 4A.

FIG. 5 is a graph showing test results when a dispersion concentration of a diamond fine particle to be dispersed in a resin of a surface layer of a transfer belt was changed in the Examples of the invention.

FIG. 6 is a graph showing test results when a thickness of a surface layer was changed in the Examples of the invention.

FIG. 7A is a table showing evaluations of optimal voltage and transfer unevenness when a diamond particle having an average particle size of 5 nm was added in a surface layer of a transfer belt and when this was not added.

FIG. 7B is a table showing evaluations of optimal voltage and transfer unevenness when a diamond particle having an average particle size of 300 nm was added in a surface layer of a transfer belt and when this was not added.

FIG. 8A is a table showing evaluations of optimal voltage and transfer unevenness when a diamond particle having an average particle size of 5 nm and carbon black were added in a surface layer of a transfer belt and when these were not added.

FIG. 8B is a table showing evaluations of optimal voltage and transfer unevenness when a diamond particle having an average particle size of 300 nm and carbon black were added in a surface layer of a transfer belt and when these were not added.

FIG. 9 is a graph showing durability test results obtained when a dispersion concentration of a diamond fine particle to be dispersed in a resin of a surface layer of an intermediate transfer belt was changed in the Examples of the invention.

FIG. 10 is a graph showing durability test results obtained when an average particle size of a diamond fine particle to be dispersed in a resin of a surface layer of an intermediate transfer belt was changed in the Examples of the invention.

FIG. 11 is a graph showing durability test results obtained when an elastic layer in an intermediate transfer belt was provided, and a dispersion concentration of a diamond fine particle to be dispersed in a resin of a surface layer thereof was changed in the Examples of the invention.

FIG. 12 is a graph showing durability test results obtained when an elastic layer in an intermediate transfer belt was provided, and a thickness of a surface layer having a diamond fine particle with an average particle size of 50 nm dispersed therein was changed in the Examples of the invention.

FIG. 13 is a graph showing durability test results obtained when an elastic layer in an intermediate transfer belt was provided, and a thickness of a surface layer having a diamond fine particle in a concentration of 1 wt % dispersed therein was changed in the Examples of the invention.

FIG. 14 is a table showing evaluation results of hollow defects and deterioration of resolution obtained when an elastic layer in an intermediate transfer belt was provided, and a surface layer having a diamond fine particle in a concentration of 1 wt % dispersed therein was provided in the Examples of the invention.

FIG. 15A is a table showing evaluation results of optimal voltage and transfer unevenness when a diamond fine particle to be dispersed in a surface layer had an average particle size of 5 nm.

FIG. 15B is a table showing evaluation results of optimal voltage and transfer unevenness when a diamond fine particle to be dispersed in a surface layer had an average particle size of 300 nm.

FIG. 16A is a table showing evaluation results of optimal voltage and transfer unevenness when in the Examples of the invention, carbon black was added in a surface layer, and a diamond fine particle to be dispersed in the surface layer had an average particle size of 5 nm.

FIG. 16B is a table showing evaluation results of optimal voltage and transfer unevenness when in the Examples of the invention, carbon black was added in a surface layer, and a diamond fine particle to be dispersed in the surface layer had an average particle size of 300 nm.

FIG. 17 is a graph showing results obtained by evaluating transfer unevenness when in the Examples of the invention, a thickness of a surface layer was 8 μm, and a resistance value of the surface layer was changed.

FIG. 18 is a graph showing results obtained by evaluating transfer unevenness when in the Examples of the invention, a thickness of a surface layer was 3 μm, and a resistance value of the surface layer was changed.

FIG. 19 is a graph showing durability test results obtained when a thickness of a surface layer in the Examples using a DLC membrane as the surface layer was changed in the invention.

FIG. 20 is a graph showing evaluation results obtained when a alignment value of a surface layer in the Examples using a DLC membrane as the surface layer was changed in the invention.

FIG. 21 is a graph showing a maximum amount of out of color alignment when a surface layer of a fluorocarbon resin having a diamond fine particle dispersed therein was provided in a rib, and when a surface layer of DC was provided in a rib in the Examples of the invention.

FIG. 22 is a view for explaining a state of measuring a degree of decomposition of a thin line in an embodiment of the invention.

FIG. 23 is a view for explaining a state of measuring a degree of transfer of an isolated point in an embodiment of the invention.

### DETAILED DESCRIPTION

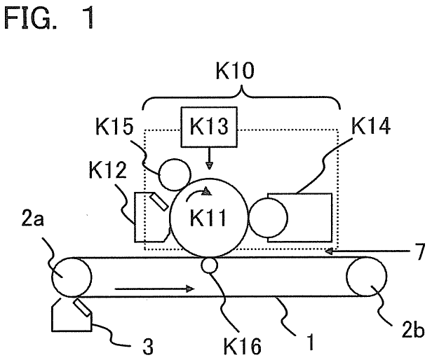

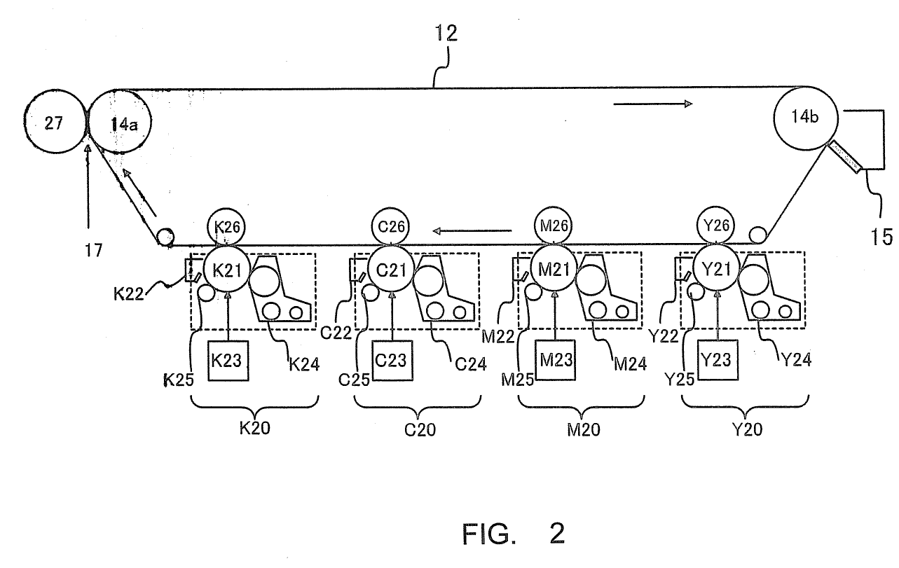

Embodiments of the image forming apparatus according to the invention are hereunder described with reference to the accompanying drawings. First of all, configuration of the image forming apparatus according to an embodiment of the invention is described on the basis of FIGS. 1 and 2.

An embodiment of an image forming apparatus for directly transferring a toner image from a photoconductor onto a material to be transferred such as paper is shown in FIG. 1. FIG. 1 is concerned with one which is a so-called direct transfer belt system and shows a diagrammatic configuration of an image forming unit of a monochromic image forming apparatus.

An image forming section K10 includes a photoconductive drum K11 as an image carrier, which is formed such that an outer periphery thereof is rotatable in the same direction against a transfer belt 1. The transfer belt 1 for conveying a toner image obtained by developing an electrostatic latent image formed on the photoconductive drum K11 in an arrow direction is arranged. The transfer belt 1 is wound around belt conveyance rollers 2a and 2b and subjected to endless running in the arrow direction at a fixed rate. The toner remaining on the transfer belt 1 is removed by a belt cleaner 3.

A non-illustrated drum motor for rotating the photoconductive drum K11 at a prescribed peripheral rate is connected to the photoconductive drum K11. An axis of the photoconductive drum K11 is disposed orthogonal to the direction into which the image is conveyed by the transfer belt 1.

In the following description, the axis direction of the photoconductive drum is defined as a horizontal scanning direction (second direction); and the direction into which the photoconductive drum is rotated, namely the rotation direction (the arrow direction in FIG. 1) of the transfer belt into which the toner image formed on the conveyance belt is once transferred is defined as a vertical scanning direction (first direction).

In the surroundings of the photoconductive drum K11, a charging unit K15 as a charging means extended in the horizontal scanning direction; a development unit K14 as a development means similarly extended in the horizontal scanning direction; a primary transfer roller K16 as a transfer means similarly extended in the horizontal scanning direction; and an image cleaner K12 as a cleaning means similarly extended in the horizontal scanning direction are disposed along the rotation direction of the photoconductive drum K11.

The primary transfer roller K16 is arranged at a position of interposing the transfer belt 1 between the primary transfer roller K16 and the photoconductive drum K11, namely inside the transfer belt 1. Also, an exposure device K13 is one for irradiating laser beams toward an exposition position of the photoconductive drum K11 for the purpose of forming an electrostatic latent image on the outer periphery of the photoconductive drum K11, and the electrostatic latent image by exposure is formed on the outer periphery of the photoconductive drum K11 between the charging unit and the development unit.

Also, the transfer roller K16 is pressed on the back face of the transfer belt 1, and by passing paper 7 which is a material to be transferred between the transfer belt 1 and the transfer roller K16, an image is transferred from the transfer belt 1 onto the paper 7.

In the monochromic image forming apparatus, there is no fear for out of color alignment or the like, and hence, accuracy against misalignment is not required. Therefore, an elastic body such as a rubber is used for a transfer belt base material, and prevention of meander of the belt unit itself, tension mechanism and the like are often omitted.

Here, an image forming process in the image forming section K10 is described.

First of all, the charging unit K15 uniformly charges the surface of the photoconductive drum K11 minus (−). A charged portion of the photoconductive drum K11 rotates, and light irradiation of image information, namely exposure is carried out by the exposure device K13. An electrostatic latent image is formed on the surface of the photoconductive drum K11 through exposure corresponding to this image.

The electrostatic latent image on the photoconductive drum K11 is subjected to reversal development with a toner in the development unit K14, whereby a toner image is formed on the photoconductive drum K11.

A bias (+) with reversed polarity to the charged polarity of the toner is applied to the transfer roller K16 by a non-illustrated direct current power source. As a result, the toner image on the photoconductive drum K11 is transferred onto the paper 7 which is a material to be transferred by a transfer electric field formed between the photoconductive drum K11 and the transfer roller K16. At that time, a part of the toner remaining on the transfer belt without being completely transferred onto the paper (residual transferred toner) is removed by the belt cleaner 3.

The paper 7 is conveyed from a non-illustrated paper cassette and sent out to the transfer belt 1 in conformity with the toner image on the transfer belt 1. Thereafter, the paper is passed through a non-illustrated fixing unit to be arranged for the purpose of fixing the transferred toner onto the paper 7, thereby obtaining a fixed image.

The transfer-finished photoconductive drum K11 is cleaned by the image cleaner K12, and thereafter, a process of charge, exposure and development is repeated.

An embodiment of an image forming apparatus of a configuration for indirectly transferring a color toner image onto a material to be transferred such as paper from a photoconductor is shown in FIG. 2. FIG. 2 is concerned with one which is a so-called intermediate transfer system. Here, an image forming apparatus of a quadruple tandem system for color intermediate transfer is shown.

Image forming sections Y20, M20, C20 and K20 are each a site for forming an electrostatic latent image corresponding to yellow (Y), magenta (M), cyan (C) and black (K), respectively and preparing a toner image developed with each of toners of these colors.

The respective image forming sections Y20, M20, C20 and K20 have photoconductive drums Y21, M21, C21 and K21, respectively which are each an image carrier to be formed such that an outer periphery thereof is rotatable in the same direction against an intermediate transfer belt 12 at a position coming into contact with the intermediate transfer belt 12. An electrostatic latent image of each color formed by each of the photoconductive drums Y21, M21, C21 and K21 is transferred onto the intermediate transfer belt 12 to be conveyed in an arrow direction in FIG. 2. The intermediate transfer belt 12 is subjected to endless running in the arrow direction at a fixed rate. The respective image forming sections Y20, M20, C20 and K20 are disposed in series along the conveyance direction of the intermediate transfer belt 12.

A non-illustrated drum motor for rotating each of the photoconductive drums at a prescribed peripheral rate is connected to each of the photoconductive drums. An axis of each of the photoconductive drums Y21, M21, C21 and K21 is disposed orthogonal to the direction into which the image is conveyed by the intermediate transfer belt 12, and the axes of the respective photoconductive drums are disposed at regular intervals each other.

In the surroundings of each of the photoconductive drums Y21, M21, C21 and K21, charging units Y25, M25, C25 and K25 as a charging means extended in the horizontal scanning direction; development units Y24, M24, C24 and K24 as a development means similarly extended in the horizontal scanning direction; primary transfer rollers Y26, M26, C26 and K26 as a transfer means similarly extended in the horizontal scanning direction; and image cleaners Y22, M22, C22 and K22 as a cleaning means similarly extended in the horizontal scanning direction are disposed, respectively along the rotation direction of the corresponding photoconductive drum. The intermediate transfer belt 12 is wound by conveyance rollers 14a and 14b and the primary transfer rollers Y26, M26, C26 and K26. The toner remaining on the intermediate transfer belt 12 is removed by a belt cleaner 15.

Each of the primary transfer rollers is arranged at a position of interposing the intermediate transfer belt 12 between the respective primary transfer roller and the corresponding photoconductive drum, namely inside the intermediate transfer belt 12. Also, each of exposure devices Y23, M23, C23 and K23 is one for irradiating laser beams of every color toward an exposure position of each of the photoconductive drums for the purpose of forming a color-separated electrostatic latent image on the outer periphery of each of the photoconductive drums, and exposure points by the exposure devices Y23, M23, C23 and K23 are each formed on the outer periphery of the photoconductive drum between the charging unit and the development unit.

Also, the intermediate transfer belt 12 is interposed between a secondary transfer roller 27 and the conveyance roller 14a. By passing paper 17 between the intermediate transfer belt 12 and the secondary transfer roller 27, a color toner image is transferred from the intermediate transfer belt 12 onto the paper 17.

Since an image forming process in each of the image forming sections Y20, M20, C20 and K20 is substantially equal to one another except that the color of the toner used for development is different, the image forming section Y20 using a yellow toner is represented and described herein.

First of all, the charging unit Y25 uniformly charges the surface of the photoconductive drum Y21 minus (−). The charged photoconductive drum Y21 forms its electrostatic latent image upon exposure corresponding to yellow image information by the exposure device Y23. The foregoing electrostatic latent image on the photoconductive drum Y21 is subjected to reversal development with a toner of yellow color, whereby a toner image is formed on the photoconductive drum Y21.

A bias (+) with reversed polarity to the charged polarity of the toner is applied to the transfer roller Y26 by a non-illustrated direct current power source. As a result, the toner image on the photoconductive drum Y21 is subjected to primary transfer onto the intermediate transfer belt 12 by a transfer electric field formed between the photoconductive drum Y21 and the transfer roller Y26.

The transfer-finished photoconductive drum Y21 is cleaned by the image cleaner Y22, and thereafter, a process of charge, exposure and development is repeated.

The same process is also carried out in each of the image forming sections M20, C20 and K20 in conformity with the timing for forming a toner image in the image forming section Y20. Magenta, cyan and black toner images formed on the photoconductors of the image forming sections M20, C20 and K20 are also successively subjected to primary transfer onto the intermediate transfer belt 12. That is, the color toner image having magenta, cyan and black colors superimposed thereon is formed on the intermediate transfer belt 12.

The paper 17 which is a material to be transferred is conveyed from a non-illustrated paper cassette and sent out to the intermediate transfer belt 12 in conformity with the color toner image on the intermediate transfer belt 12.

A bias (+) with reversed polarity to the charged polarity of the toner is applied to the secondary transfer roller 27 by a non-illustrated direct current power source. As a result, the toner image on the intermediate transfer belt 12 is transferred onto the paper 17 which is a material to be transferred by a transfer electric field formed between the intermediate transfer belt 12 and the secondary transfer roller 27.

At that time, a part of the toner remaining on the intermediate transfer belt 12 without being completely transferred onto the paper 17 (residual transferred toner) is removed by the belt cleaner 15. Thereafter, the paper is passed through a non-illustrated fixing unit to be arranged for the purpose of fixing the transferred toner onto the paper 17, thereby obtaining a fixed image.

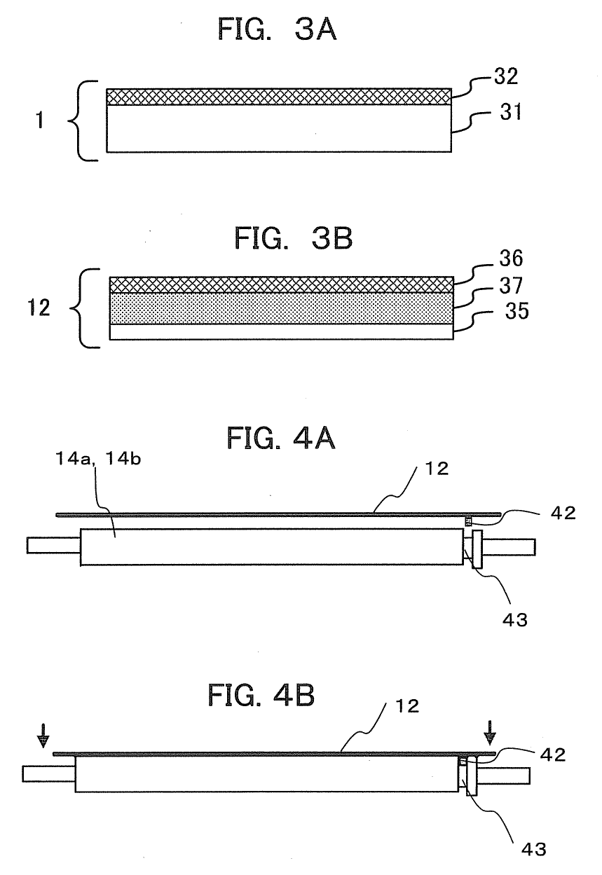

A configuration of the transfer belt 1 according to an embodiment of the invention which is used in the case of employing a direct transfer system, such as the monochromic image forming apparatus as shown in FIG. 1, is shown in FIG. 3A.

FIG. 3A shows a cross-sectional view of the transfer belt 1. The transfer belt 1 is comprising a belt base material 31 and a surface layer 32. Rubber or a polyimide resin may be used for the belt base material 31. In particular, in the case of color, positional accuracy such as out of color alignment is emphasized, and therefore, a resin such as polyimides (those having a high Young's modulus) which are substantially free from elongation may be used as a base material as the belt base material 31.

As foregoing rubber base material, those having a volume resistance of from about 10e6 Ω·cm to 10e13 Ω·cm are useful. In the case of a transfer belt, a semi-conductive base material is especially desirable as the base material. Also, as to the volume resistance of the foregoing resin such as polyimides (those having a high Young's modulus), those having a volume resistance of from 10e6 Ω·cm to 10e13 Ω·cm are useful.

A configuration of the intermediate transfer belt 12 according to an embodiment of the invention which is used for the color image forming apparatus as shown in FIG. 2 is shown in FIG. 3B. The intermediate transfer belt having such a structure is not limited to the use in the color image forming apparatus, but when employing the intermediate transfer system, such an intermediate transfer belt is used. The intermediate transfer belt 12 may be comprising only a belt base material 35 and a surface layer 36, and an elastic layer 37 may be provided as an interlayer therebetween.

Rubber or a polyimide resin may be used for the belt base material 35. In particular, in the case of color, positional accuracy such as out of color alignment is emphasized, and therefore, it is preferable to use, as the belt base material 35, a resin such as polyimides (those having a high Young's modulus) which are substantially free from elongation as a base material.

When used as an intermediate transfer belt, since it carries a toner image thereon, influences which the characteristics give to the image are large as compared with those in the direct transfer. From the standpoints of high image quality and transfer properties against concave-convex graph paper and the like, it would be better to provide an elastic layer as the interlayer between the surface layer and the base material of the transfer belt. For this elastic layer, it is preferable to use a urethane rubber or a silicon rubber.

A thickness of the elastic layer may be in the range of from about 30 μm to about 300 μm. When the thickness of the elastic layer is less than 30 μm, hollow defects are easily generated, whereas when it exceeds 300 μm, the resolution is deteriorated, and therefore, it is not preferable.

It is preferable that each of the surface layers 32 and 36 is comprising a fluorocarbon resin containing a diamond fine particle or a DLC layer, a thickness of which is in the range of from about 1.5 μm to about 8 μm, and more preferably in the range of from about 2 μm to about 7 μm. When the thickness of the surface layer falls within the foregoing range, the durability is explicitly enhanced, thereby prolonging the life. When the thickness of the surface layer is less than 1.5 μm, the surface layer is too thin so that the absolute durability is deteriorated, thereby shortening the life. On the other hand, when it exceeds 8 μm, the surface layer is too thick so that the durability is slightly deteriorated, and therefore, it is not preferable.

### Example 1

### Case of Using, as a Surface Layer, a Resin Having a Diamond Fine Particle Dispersed Therein

As the diamond fine particle, for example, those available from New Metals & Chemicals Corporation or Sumitomo Coal Mining Co., Ltd. can be used. In the case where the diamond fine particle is manufactured by blasting, the amount of impurities is high, and the particle size distribution is relatively broad. Hence, it is generally carried out to wash it with concentrated sulfuric acid or the like.

Also, though there is a method of synthesizing it from graphite by a high-pressure high-temperature apparatus or other method, since the Examples of the invention were carried out using a previously purified diamond fine particle, a fine particle preparation step is omitted. Such a diamond fine particle can be dispersed in a fluorocarbon resin such as PFA, PTFEL etc. Also, if desired, a conductive agent such as carbon, etc. can be dispersed in combination for the transfer material.

The content of the diamond fine particle to be dispersed is desirably in the range of from about 0.01 to about 40%. When the content of the diamond fine particle is less than 0.01%, the effects of the diamond fine particle are not obtainable. When it exceeds 40%, the surface layer becomes brittle, the follow-up properties are deteriorated, and a crack is generated within a short period of time. Therefore, it is not preferable.

An average particle size of the diamond fine particle is desirably in the range of from about 5 nm to about 300 nm. When the diamond fine particle is too large, an edge of the cleaning blade is easily broken, whereby the effects become small.

As to the resistance of the surface layer, when it is too high, the belt surface is charged, charge-up is caused in the repeated use, a phenomenon in which the transfer condition is changed is generated, and influences by the resistance unevenness are easy to appear. Therefore, it is desirable to regulate the volume resistance to from about 10e8 Ω·cm to 10e14 Ω·cm. However, when the surface layer is thin, even if the resistance of the surface layer itself is high, it can be substantially used. As a standard, when after forming into a belt, the surface resistance of the belt is measured in a state that the surface layer is provided and favorably falls within the range of from about 10e9 to 10e15 Ω/sq. In the case where the resistance of the belt including the surface layer exceeds the foregoing range, it is desirable to regulate the resistance by adding the diamond fine particle to the surface layer and dispersing an already-known conductive filler.

### Example 1a

### Case of Applying the Invention to a Transfer Belt of a Direct Transfer System

A durability test was carried out in a state of not developing with a toner in the configuration of the image forming apparatus as shown in FIG. 1 without performing paper-passing of paper. Also, a halftone image with an area ratio of 50% was printed every 1,000 sheets of paper on the belt without passing paper, thereby confirming a cleaning performance by the belt cleaner. On that occasion, the toner on the belt after cleaning passing was collected on a mending tape, thereby judging whether or not a difference between a reflection density in sticking a mending tape not having a toner collected thereon to white paper and a reflection density in a mending tape having a toner collected thereon was kept at not more than 0.05.

The reflection density was measured by a Macbeth densitometer. The measurement was carried out randomly in five points, and the case where the difference exceeded even in one point was judged as “NG”. Furthermore, the case where streak-like cleaning failure or the like was found in a visually observed state was also immediately judged as “NG”. Also, the measurement of the resistance in this Example was carried out using HIRESTA, manufactured by Mitsubishi Petrochemical Co., Ltd., a measurement voltage was 250 V by an HR probe, and a value after lapsing 30 seconds was employed.

As the transfer belt 1 shown in FIG. 3A, a fluorocarbon resin coated in a thickness of about 3 μm as the surface layer 32 on an NBR rubber having a thickness of 500 μm as the belt base material 31 was used.

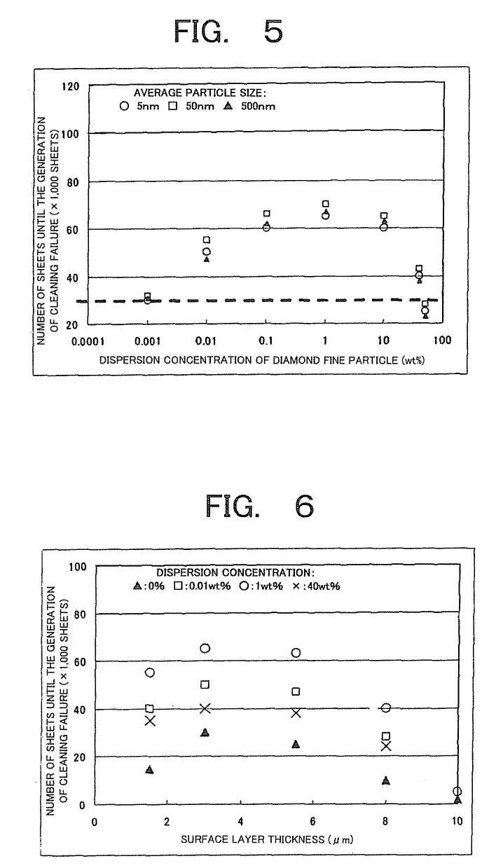

As the rubber base material, one having a volume resistance of 1×10e9 [Ω·cm] was used herein. In general, rubber base material having a volume resistance in the range of from 10e6 Ω·cm to 10e13 Ω·cm are useful. Diamond fine particles having an average particle size of 5 nm (◯), 50 nm (□) and 300 nm (▴), respectively were dispersed in the surface layer 32 while changing its concentration, and the resulting effect was compared. The evaluation results are shown in FIG. 5. The abscissa represents a dispersion concentration (wt %) of diamond fine-particle; and the ordinate represents the number of sheets until the generation of cleaning failure (×1,000 sheets).

In FIG. 5, the dotted line expresses the conventional case of not containing a diamond fine particle. In the graphs showing the results of durability test as described below, each of the dotted lines similarly expresses the case of not containing a diamond fine particle.

Also, as to each of the cases where the dispersion concentration of the diamond fine particle is 0% (▴), 0.01 wt % (□), 1 wt % (◯) and 40 wt % (X), with the average particle size of the diamond particle being fixed at 50 nm, the same durability test was carried out while changing the thickness of the surface layer. The evaluation results are shown in FIG. 6. In FIG. 6, the abscissa represents a thickness (μm) of the surface layer 32; and the ordinate represents the number of sheets until the generation of cleaning failure (×1,000 sheets).

It is noted from the results of the durability test shown in FIG. 5 that the durability is enhanced in the range where the diamond fine particle is dispersed in a concentration of from 0.01% to 40%. However, when the diamond was added too much, the surface layer became brittle, the follow-up properties were deteriorated, and a crack was generated within a short period of time.

Also, it can be understood from the results of the durability test shown in FIG. 6 that when the surface layer is too thin, the life becomes short; and when the surface layer is too thick, since the rubber base material is considerably elongated, a crack is generated on the surface layer, and the life becomes short. Furthermore, in all of the cases where the thickness of the surface layer is from 1.5 μm to 8 μm, there were obtained the results that the transfer belt 1 provided with a surface layer having a diamond fine particle dispersed therein is explicitly long in life.

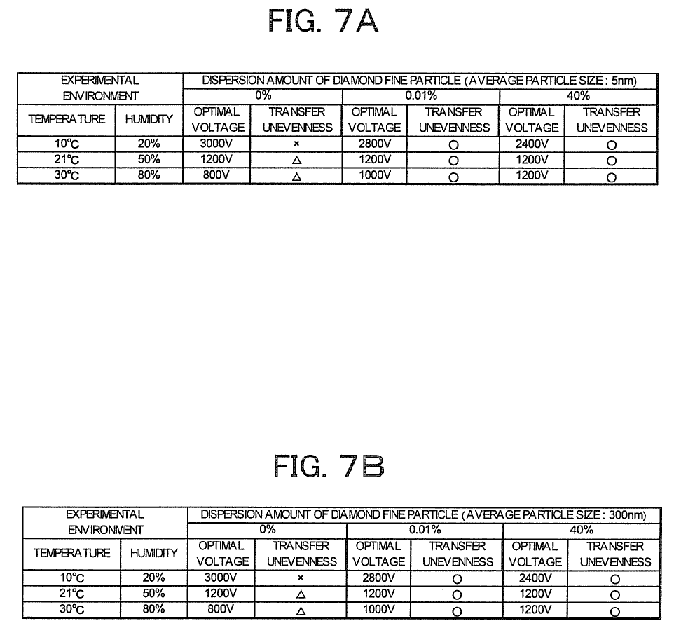

Optimal voltage and transfer unevenness were examined in the test environment at a temperature and a humidity of 10° C. and 20%, 21° C. and 50% and 30° C. and 80%, respectively. The test results are shown in FIGS. 7A and 7B.

In the configuration of the transfer belt 1, in the case where the average particle size of the diamond fine particle is 5 nm and 300 nm, respectively, an optimal transfer voltage at which the transfer efficiency is the maximum and transfer unevenness of a halftone image at that time were compared while changing the test environment.

As to the transfer unevenness, after transferring a halftone image having an area ratio of 50% onto paper, a residual transferred toner remaining on a photoconductor was subjected to taping by a mending tape; a reflection density was measured in five points in a longitudinal direction of the photoconductor; and the case where a difference between the maximum value and the minimum value in the five points was not more than 0.02 was evaluated as “◯”, the case where it was from 0.03 to 0.04 was evaluated as “Δ”, and the case where it was 0.05 or more was evaluated as “x”.

The taping was carried out three times for a single condition; the comparison was made in the five points each time; and the case of exceeding the foregoing standards even one time was dealt as “Δ” or “x”.

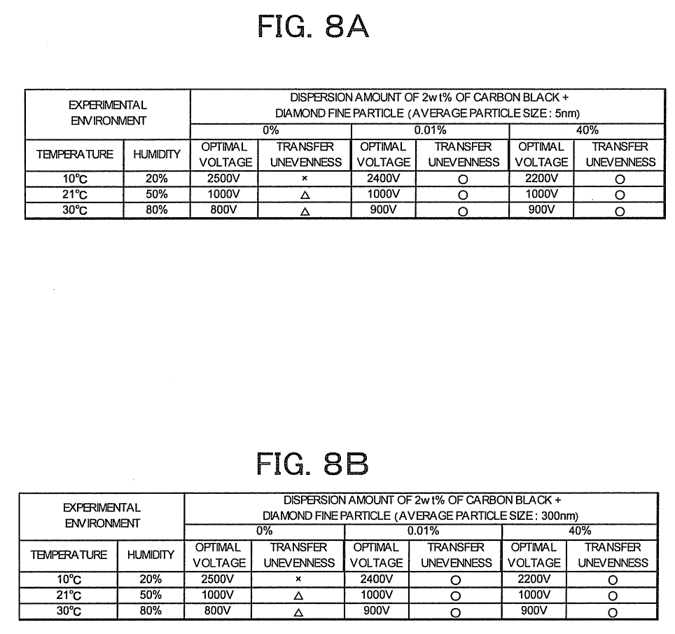

Also, the test results obtained in the case of further dispersing a diamond fine particle having an average particle size of 5 nm and 300 nm, respectively in a state of dispersing 2 wt % of carbon black as a conductive agent in a fluorocarbon resin surface layer are shown in FIGS. 8A and 8B. Optimal voltage and transfer unevenness were examined in the test environment at a temperature and a humidity of 10° C. and 20%, 21° C. and 50%, and 30° C. and 80%, respectively.

It is noted from the foregoing that when the test environment is changed, a difference of the optimal transfer bias is slightly small. For example, in FIG. 7A, when the diamond fine particle is not dispersed (0%), the optimal voltage is 3,000 V and 800 V at a temperature of 10° C. and 30° C., respectively. However, when 40% of the diamond fine particle is dispersed, the optimal voltage is 2,400 V and 1,200 V at a temperature of 10° C. and 30° C., respectively.

This demonstrates that the change in resistance of the belt surface layer due to the environment is suppressed, and it is noted that the control of the environment such as a transfer bias can be simplified. Furthermore, when the diamond fine particle is dispersed, the transfer unevenness is improved. That is, it is noted that by dispersing the diamond fine particle, the unevenness in resistance of the belt surface layer and the environmental change are improved, and electrical characteristics and transfer performance as the transfer belt are enhanced.

In FIGS. 8A and 8B, by dispersing carbon black in the surface layer, a necessary bias decreased. This tendency is the same as in the case of FIGS. 7A and 7B, and it is noted that when the diamond fine particle is added, the environmental stability of resistance and resistance unevenness are improved. That is, it is noted that by dispersing the diamond fine particle, even the dispersed state of carbon black which is a conductive filler was improved, whereby uniformity of the resistance was enhanced.

### Example 1b

### Case of Applying the Invention to an Indirect Transfer Belt of an Indirect Transfer System

The foregoing tests were carried out in the monochromic image forming apparatus whose configuration is shown in FIG. 1. Also, as described previously, in the transfer using a rubber base material, the monochromic configuration is more likely adopted. If the control of out of color alignment or the like can be well achieved, it is evident that the transfer belt of this configuration can also be used in a color image forming apparatus whose configuration is shown in FIG. 2 and that the effects of the invention are also the same in that situation.

Also, in particular, in a color image forming apparatus of a tandem system, since a distance between stations of respective colors is short, charge-up on the belt surface is a serious problem. In that case, it is noted that in the surface layer using a diamond fine particle, charge-up is more hardly generated because even when the surface layer is formed thin as compared with the conventional fluorocarbon layers or the like, it is also able to attain durability, namely so far as the volume resistance is equal, when the thickness of the surface layer is thin, an actual resistance value of the surface layer becomes small.

Next, the case of applying the invention to an intermediate transfer belt to be used in the image forming apparatus of an intermediate transfer system is described. Here, the case of using the intermediate transfer belt 12 of the color image forming apparatus as shown in FIG. 2 is taken as an example.

Even in that case, the same effects as in the case of direct transfer are basically obtainable. However, in the case of color, positional accuracy such as out of color alignment is emphasized, and therefore, a resin such as polyimides (those having a high Young's modulus), etc. is often used as the belt base material 35 shown in FIG. 3B. Such a material is substantially free from elongation of the base material as has been described previously.

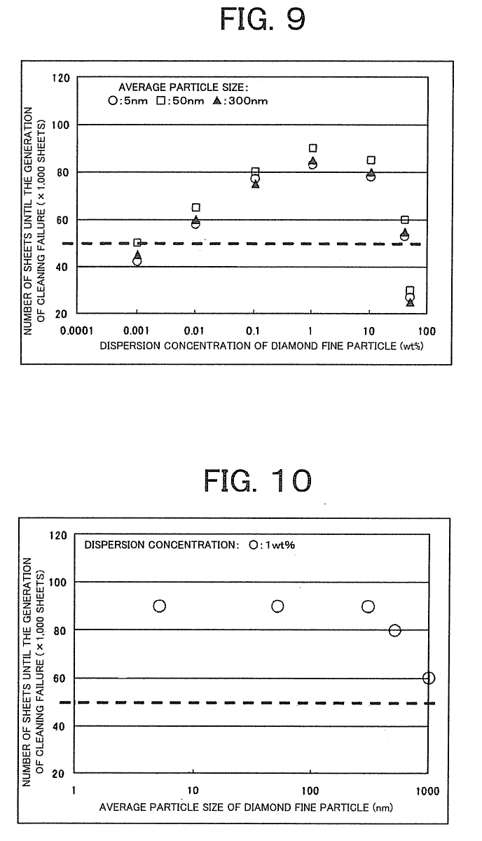

In the case of an intermediate transfer belt system, the same durability test was also carried out. The results obtained in this durability test are shown in FIG. 9. In FIG. 9, the abscissa represents a dispersion concentration (wt %) of diamond fine particle; and the ordinate represents the number of sheets until the generation of cleaning failure (×1,000 sheets).

As the intermediate transfer belt 12 shown in FIG. 3B, one prepared by coating a fluorocarbon resin in a thickness of 3 μm as the surface layer 36 on a polyimide resin having a thickness of 75 μm as the belt base material 35 was used.

As the polyimide resin, one having a volume resistance of 1×10e9 [Ω·cm] was used herein. Diamond fine particles having an average particle size of 5 nm (◯), 50 nm (□) and 300 nm (▴), respectively were dispersed in the surface layer 36 while changing its concentration, and the resulting effect was compared.

It is noted from the results that similar to the case where the belt base material is a rubber, the durability is enhanced in the range where the diamond fine particle is dispersed in a concentration of from 0.01% to 40%. A phenomenon where when the diamond fine particle was added too much, the surface layer became brittle, the follow-up properties were deteriorated, and a crack was generated within a short period of time is also the same. However, since the belt base material is a resin, its degree of deterioration was slightly better in level.

Subsequently, the same durability test was carried out in the case of changing the average particle size of the diamond fine particle to be dispersed in the surface layer within the range of from 5 nm to 1 μm while fixing the dispersion concentration of the diamond fine particle at 1 wt %. The test results are shown in FIG. 10. In FIG. 10, the abscissa represents an average particle size (nm) of diamond fine particle; and the ordinate represents the number of sheets until the generation of cleaning failure (×1,000 sheets).

According to the results of this durability test, in all of the cases of dispersing the diamond fine particle, the number of sheets until the generation of cleaning failure became large, and the effect of durability was revealed as compared with the case of not using a diamond fine particle. As shown in FIG. 10, though when the particle size was from 5 nm to 300 nm, the stable durability effect was found, when the particle size of the diamond fine particle exceeded this range, for example, 500 nm, the effect of durability became small. As a result of observation of a cleaning blade when cleaning failure was generated, an edge part was broken. When the diamond fine particle is too large, an edge of the cleaning blade is easily broken, whereby the effect becomes small.

In the case of providing the elastic layer 37 on the intermediate transfer belt 12 as shown in FIG. 3B, the same durability test was carried out. As the intermediate transfer belt 12, one prepared by using a polyimide resin having a thickness of 75 μm as the belt base material 35 and a urethane rubber having a thickness of 100 μm as the elastic layer 37 and coating a fluorocarbon resin in a thickness of 3 μm as the surface layer 36 was used.

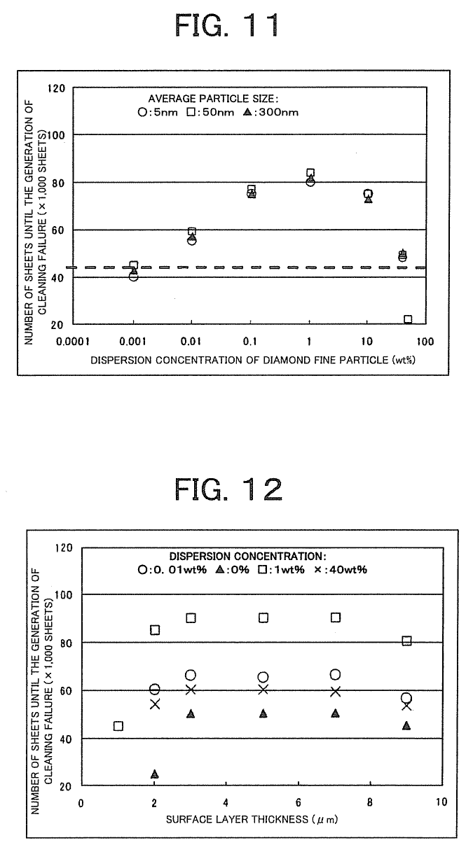

The same durability test was carried out by a diamond fine particle having an average particle size of 5 nm (◯), 50 nm (□) and 300 nm (▴), respectively in the surface layer 36 while changing its concentration, and the resulting effect was compared. The test results are shown in FIG. 11. In FIG. 11, the abscissa represents a dispersion concentration (wt %) of diamond fine particle; and the ordinate represents the number of sheets until the generation of cleaning failure (×1,000 sheets).

It is noted from the results of this durability test that the durability is enhanced within the range where the diamond fine particle is dispersed in a concentration of from 0.01% to 40%; and that as to the particle size of 5 nm, 50 nm and 300 nm, the tendency does not change from that as described previously. When the dispersion concentration of the diamond fine particle to be dispersed is 500 wt % or more, the surface layer becomes brittle and is broken, whereby the durability is deteriorated.

Subsequently, by providing a fluorocarbon resin in which the dispersion concentration of the diamond fine particle is 0% (▴), 0.01 wt % (□), 1 wt % (◯) and 40 wt % (X), respectively, with the average particle size of the diamond fine particle being fixed at 50 nm, on the elastic layer, the same durability test was carried out while changing the thickness of the surface layer. The results of the durability test are shown in FIG. 12. In FIG. 12, the abscissa represents a thickness (μm) of the surface layer; and the ordinate represents the number of sheets until the generation of cleaning failure (×1,000 sheets).

It is noted from the results of this durability test that in all of the cases, the durability is improved as compared with the case of not adding a diamond fine particle. However, it is noted that the concentration of about 1 wt % is especially preferably.

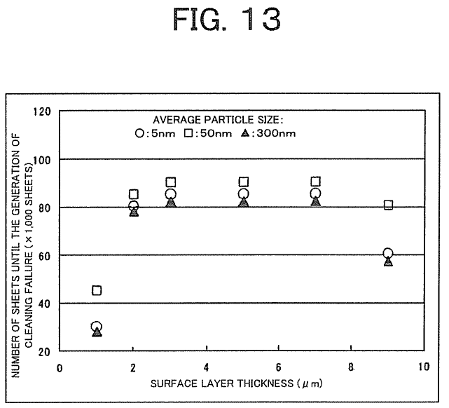

Also, by providing a fluorocarbon resin in which the average particle size of the diamond fine particle is 5 nm (◯), 50 nm (□) and 300 nm (▴), respectively, with the dispersion concentration of the diamond fine particle being fixed at 1 wt %, on the elastic layer, the same durability test was carried out while changing the thickness of the surface layer. The results of the durability test are shown in FIG. 13. In FIG. 13, the abscissa represents a dispersion concentration (wt %) of the diamond fine particle; and the ordinate represents the number of sheets until the generation of cleaning failure (×1,000 sheets).

It is noted from the results of this durability test that when the surface layer 36 is too thin, as matter of course, the absolute durability is liable to be deteriorated; and the thickness of the surface layer 36 is desirably 2 μm or more. Also, when the surface layer 36 is too thick, the durability is liable to be slightly deteriorated. However, in comparison with the case where the belt base material 35 is made of a rubber (FIG. 6), the amount of deformation into the surface layer is different, and therefore, results of a relatively good level are revealed.

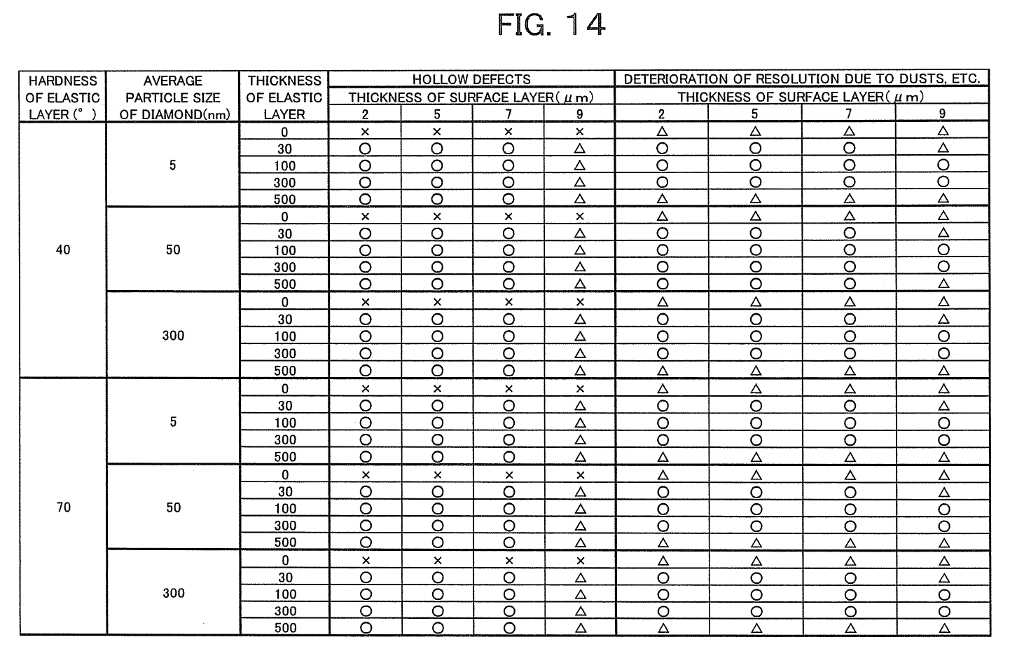

Now, as the effect of the elastic layer 37, there is exemplified prevention of hollow defects. The hollow defects as referred to herein refer to a phenomenon in which in transferring a thin-line image, the interior of the thin line remains without being transferred. This phenomenon is easily generated when the intermediate transfer belt is made of a rigid material such as a resin. The results obtained by comparing the generation state of hollow defects when the thickness of the surface layer and the thickness of the elastic layer are changed are shown on the left-hand side of FIG. 14.

The generation state of hollow defects in the case of changing the average particle size of the diamond fine particle, the thickness of the surface layer 36 and the thickness of the elastic layer 37 and the deterioration in resolution by transfer were compared.

As the intermediate transfer belt 12 shown in FIG. 3B, a polyimide resin having a thickness of 75 μm was used as the belt base material 35, a urethane rubber having a hardness of 40° or 70° was used as the elastic layer 37, and a fluorocarbon resin having 1 wt % of a diamond fine particle dispersed therein was used as the surface layer 36.

For the comparison of hollow defects, eight kinds of each ten of thin lines of 1-dot line, 2-dot line, 3-dot line and 4-dot line widths with 600 dpi were prepared in a length of 10 mm in the longitudinal and transverse directions, respectively (80 in total).

As a result of transferring these thin lines onto the intermediate transfer belt 12, the case where the hollow defects could be confirmed in three or more points was defined as “x”; the case where the hollow defects could be confirmed in one or two points was defined as “Δ”; and the case where the hollow defects could not be confirmed at all was designated as “◯”. Also, the same evaluation was carried out while changing a developing amount to the photoconductor in three ways of 0.5 mg/cm², 0.7 mg/cm² and 0.9 mg/cm². The case where even one of them was corresponding to the foregoing was dealt as the evaluation of “x” or “Δ”.

According to this, when the thickness of the elastic layer 37 is 30 μm or more, and the thickness of the surface layer 36 is not more than 7 μm, the hollow defects were not generated. Also, even when the thickness of the surface layer 36 becomes thick to an extent of 9 μm, the effect was found as compared with the case where the elastic layer 37 was not provided. Also, as to the hardness of the elastic layer, a significant difference in the effect was not found between 40° and 70° in this test.

The right-hand side of FIG. 14 is concerned with the deterioration of resolution due to the transfer while changing the thickness of each of the surface layer and the elastic layer.

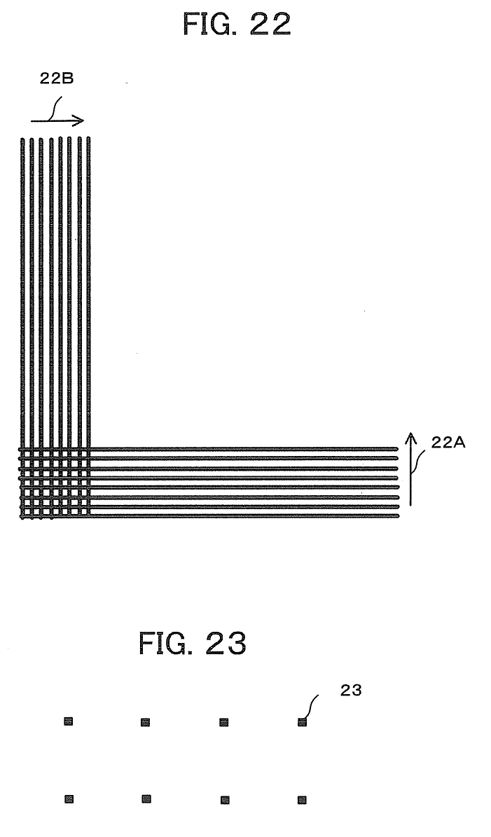

As to the resolution, whether or not a 1on-1off printing image of a 1-dot line with 600 dpi could be decomposed and whether or not an isolated point of 1 dot with 600 dpi could be transferred were visually confirmed by a microscope. Here, the decomposition of the lon-loff printing image and the transfer of an isolated point are described with reference to FIGS. 22 and 23.

As shown in FIG. 22, the 1on-1off printing image of 600 dpi is one exposed such that eight 42 μm-wide thin lines are arranged at intervals of 42 μm and in a length of 20 mm in each of a horizontal scanning direction (arrow 22A) and a vertical scanning direction (arrow 22B) of an exposure signal and printed on a photoconductor. A 1on-1off printing image in each of the longitudinal and transverse directions is then obtained by means of development. The image developed on this photoconductor was transferred onto the intermediate transfer bell in the transfer section, and the image before and after the transfer was microscopically compared, thereby confirming whether or not the image was collapsed or rubbed by the transfer.

Also, as shown in FIG. 23, after exposing a 1-dot signal of 600 dpi (42 μm) (point 23) by an exposure signal, development was carried out, thereby obtaining an isolated point image on the photoconductor. Approximately eight isolated points were prepared at intervals of 5 mm in the longitudinal and transverse directions, and whether or not all of these points were rubbed after the transfer was judged.

The case where both the 1-dot line and the isolated point could be resolved is designated as “◯”; the case where either one of them could not be confirmed is designated as “Δ”; and the case where the both could not be confirmed is designated as “x”.

It is noted from the results of this test that when the thickness of the elastic layer 37 becomes thick to an extent of 500 μm, the 1-dot line collapses, and the resolution is deteriorated. Thus, it is noted that the thickness of the elastic layer is desirably not more than 300 μm.

That is, when these results are summarized, it is noted that the thickness of the surface layer 36 is desirably 2 μm or more while taking into account the durability and not more than 9 μm (preferably not more than 7 μm) in view of preventing the hollow defects. Also, it is noted that the thickness of the elastic layer 37 is desirably from 30 to 300 μm.

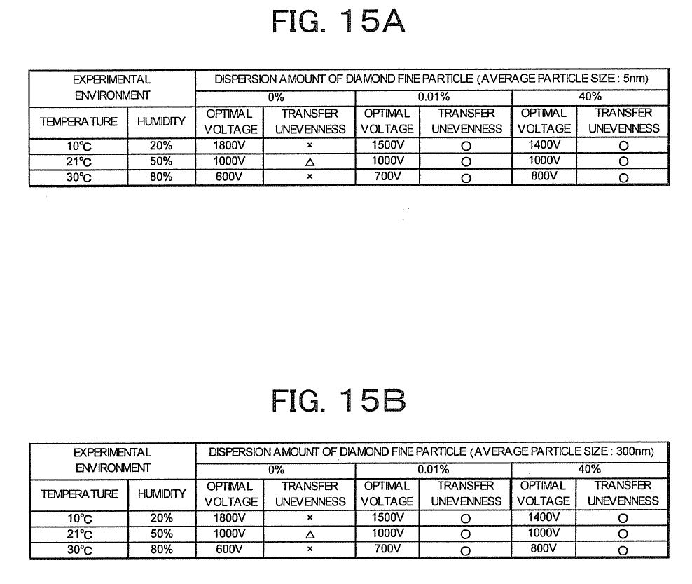

Also, in the configuration of the intermediate transfer belt, in the case where the average particle size of the diamond fine particle was 5 nm and 300 nm, respectively, an optimal transfer voltage at which the transfer efficiency is the maximum and transfer unevenness of a halftone image at that time were compared by changing the test environment. The results are shown in FIGS. 15A and 15B.

As to the evaluation method, since the intermediate transfer system is concerned, the image of the photoconductor was directly transferred onto the belt but not onto the paper. As to the transfer unevenness, after transferring a halftone image having an area ratio of 50% onto the paper, a residual transferred toner remaining on the photoconductor was subjected to taping by a mending tape; a reflection density was measured in five points in a longitudinal direction of the photoconductor.

The case where a difference between the maximum value and the minimum value in the five points was not more than 0.02 was evaluated as “◯”, the case where it was from 0.03 to 0.04 was evaluated as “Δ”, and the case where it was 0.05 or more was evaluated as “x”. The taping was carried out three times for a single condition; the comparison was made in the five points each time; and the case of exceeding the foregoing standards even one time was dealt as “Δ” or “x”.

It is noted from the evaluation results shown in FIGS. 15A and 15B that when the test environment is changed, a difference of the optimal transfer bias is slightly small. For example, in FIG. 15A, when the diamond fine particle is absent in the surface layer, the optimal voltage is 1,800 V and 600 V at 10° C. and 30° C., respectively. On the other hand, when 0.01% of the diamond fine particle having an average particle size of 5 nm is dispersed in the surface layer, the optimal voltage is 1,500 V and 70 V, respectively.

This demonstrates that the change in resistance of the surface layer of the intermediate transfer belt due to the environment is suppressed, and it is noted that the control of the environment such as a primary transfer bias can be simplified. Furthermore, the transfer unevenness, namely the unevenness in resistance of the surface layer of the transfer belt and the environmental change are improved.

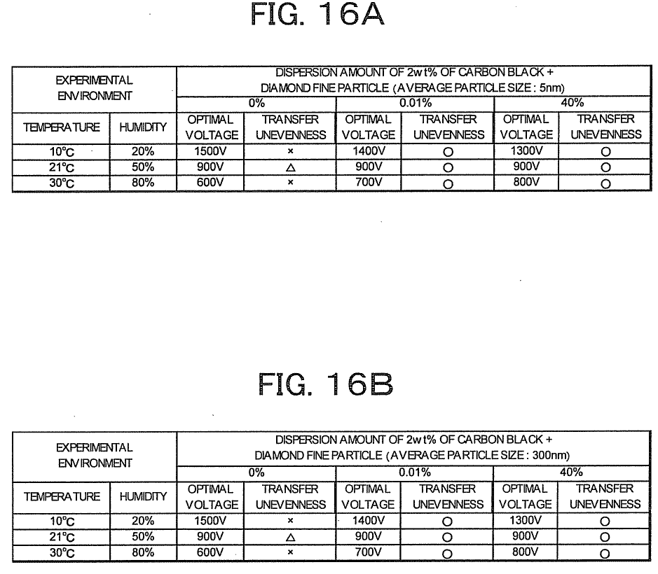

The results obtained in the case of further dispersing a diamond fine particle having an average particle size of 5 nm and 300 nm, respectively in a state of dispersing 2 wt % of carbon black as a conductive agent in a fluorocarbon resin surface layer are shown in FIGS. 16A and 16B.

It is noted from these results that by dispersing carbon black, a necessary bias decreased. This tendency is the same as in the case of FIGS. 15A and 15B, and it is noted that when the diamond fine particle is added, the environmental stability of resistance and resistance unevenness are improved. That is, it is noted that by dispersing the diamond fine particle, even the dispersed state of carbon black which is a conductive filler was improved, whereby uniformity of the resistance was enhanced.

Also, the resistance of the surface layer is the same as in the direct transfer. When the resistance value is too high, not only the surface of the transfer belt is charged, thereby causing charge-up in repeated use, whereby a phenomenon wherein the transfer condition is changed is generated, but also influences of the resistance unevenness are likely revealed. Therefore, it is desirable to regulate the volume resistance to from about 10e8 Ω·cm to 10e14 Ω·cm.

However, when the surface layer is thin, even if the resistance of the surface layer itself is high, it can be substantially used. The surface resistance of the transfer belt is preferably within the range of from about 10e9 to 10e15 Ω/sq measured in a state that the surface layer is provided after forming into an intermediate transfer belt.

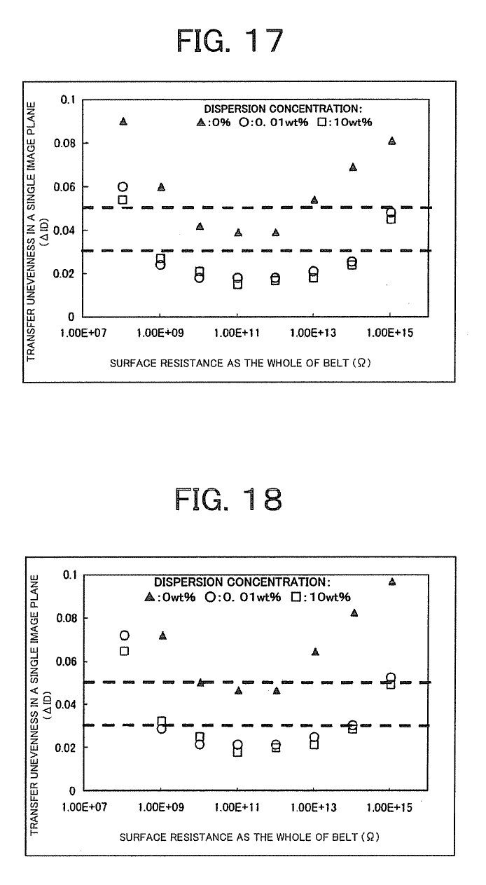

The results obtained by evaluating the transfer unevenness in the ordinary temperature and ordinary humidity environment while changing the resistance of the surface layer of the intermediate transfer belt are shown in FIGS. 17 and 18. In FIGS. 17 and 18, the abscissa represents a surface resistance (Ω) as the whole of belt; and the ordinate represents transfer unevenness (ΔID) in a single image plane. FIG. 17 shows the results when the thickness of the surface layer is 8 μm; and FIG. 18 shows the results when the thickness of the surface layer is 3 μm. The measurement method is the same as in the cases of FIGS. 15A, 15B, 16A and 16B. In FIGS. 17 and 18, as to two dotted lines, a portion below the lower dotted line, namely not more than 0.03, shows that the transfer unevenness is small; and a portion above the upper dotted line, namely 0.05 or more shows that the transfer unevenness is too large so that the resulting transfer belt is no longer useful. In FIG. 20 described later, the same is applicable to two dotted lines.

The test was carried out by using a polyimide resin having a thickness of 75 μm and a volume resistance of from about 10e8 Ω·cm to 10e14 Ω·cm as the belt base material, forming a urethane rubber layer (100 μm in thickness) having a volume resistance of the same degree thereon, and preparing two kinds of surface layers of 3 μm and 8 μm. The resistance of the surface layer was regulated by dispersing carbon black in the fluorocarbon resin surface layer. The case of dispersing the diamond fine particle in a concentration of 0% (▴), 0.01 wt % (◯) and 10 wt % (□) therein was compared.

It is noted from the foregoing that as shown in FIGS. 15A, 15B, 16A and 16B, when the diamond fine particle was added, the transfer unevenness was small as compared with the case of not using a diamond fine particle.

Furthermore, in the case where the thickness of the surface layer is 3 μm, the resistance unevenness is easily generated as a whole as compared with the case where the thickness of the surface layer is 8 μm. However, it is noted that by adding a diamond fine particle, the resistance unevenness is drastically improved and that when the surface resistance as the whole of belt is in the range of from 10e9 to 10e15 Ω/sq., in both of the case where the thickness of the surface layer is 3 μm and the case where the thickness of the surface layer is 8 μm, a difference in concentration of the transfer unevenness is generally suppressed to not more than 0.05, whereby a high-quality image is obtained.

The measurement of the resistance in this Example was carried out using HIRESTA, manufactured by Mitsubishi Petrochemical Co., Ltd., a measurement voltage was 250 V by an HR probe, and a value after lapsing 30 seconds was employed.

### Example 2

### Case of Using DLC in a Surface Layer

In the foregoing Examples, the case of dispersing a diamond fine particle in the surface layer has been described. However, according to the invention, it is also possible to enhance the durability of the transfer belt by using diamond-like carbon (DLC) as the surface layer.

A DLC thin membrane is generally prepared by a CVD method or the like. In recent years, there is proposed a method of achieving CVD at a low temperature or the like. For example, an F-DLC membrane available from Nippon ITF Inc. can be used. This is one in which DLC coating can be achieved on a polymer by fabrication at a low temperature, and confirmation of the effect using this was carried out.

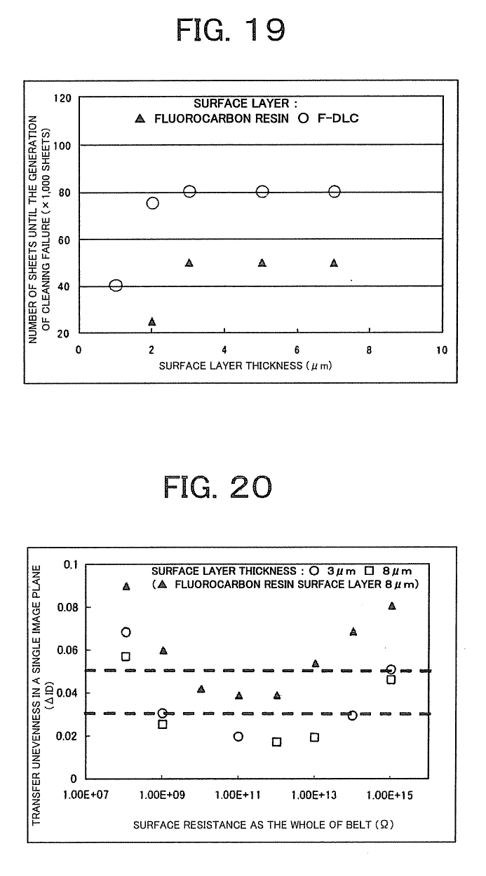

FIG. 19 shows the results obtained by comparing the durability while changing the thickness of the F-DLC membrane. In FIG. 19, the abscissa represents a thickness (μm) of the surface layer; and the ordinate represents the number of sheets until the generation of cleaning failure (×1,000 sheets). In FIG. 19, “◯” shows the case where a polyimide resin having a thickness of 75 μm is used as the belt base material, a urethane rubber having a thickness of 100 μm is used as the elastic layer, and an F-DLC membrane is used as the surface layer. In FIG. 19, “▴” shows the case where the surface layer is made of a fluorocarbon resin.

It is noted from the results shown in FIG. 19 that even in the case of using DLC as the surface layer, the same effect as in the case of dispersing a diamond fine particle is obtained. The matter that when the thickness of the surface layer is 2 μm or more, substantially stable durability is obtained exhibits the same tendency as in the case of dispersing a diamond fine particle. Furthermore, as to the resistance unevenness, the same effect as in the case of adding a diamond fine particle while using a fluorocarbon resin in the surface layer is obtained.

FIG. 20 is concerned with the results obtained in the case of changing the thickness of the surface layer. In FIG. 20, the abscissa represents a surface resistance (Ω) as the whole of belt; and the ordinate represents transfer unevenness (ΔID) in a single image plane. A polyimide resin is used as the belt base material, and a urethane rubber having a thickness of 100 μm is used as the elastic layer. “▴” shows the case where a fluorocarbon resin having a thickness of 8 μm is used as the surface layer; “◯” shows the case where an F-DLC membrane having a thickness of 3 μm is used as the surface layer; and “□” shows the case where an F-DLC membrane having a thickness of 8 μm is used as the surface layer. In FIG. 20, as to two dotted lines, a portion below the lower dotted line, namely not more than 0.03, shows that the transfer unevenness is small; and a portion above the upper dotted line, namely 0.05 or more shows that the transfer unevenness is too large so that the resulting transfer belt is no longer useful.

When an F-DLC coated membrane was used as the surface layer, the transfer unevenness was compared in the case of using an F-DLC layer having a thickness of 3 μm or 8 μm and the case of using a diamond fine particle-free fluorocarbon resin surface layer having a thickness of 8 μm while changing the surface resistance as a whole of the belt. The resistance of the DLC membrane was regulated by the condition at the fabrication.

Though the resistance of the DLC membrane was regulated by the condition at the fabrication, as compared with the case of dispersing a diamond fine particle in the fluorocarbon resin surface layer, the test could not be carried out while finely changing the condition.

However, it is noted from FIG. 20 that the case where the thickness of the DLC membrane is 3 μm and the case where the thickness of the DLC membrane is 8 μm exhibit substantially the same tendency and reveal substantially the same characteristics as in the case of using a diamond fine particle while the number of measurement points is small.

As described previously, by using DLC in the surface layer of the belt and optimizing the surface resistance as a transfer belt, it becomes possible to obtain a high-quality image which has not been obtained in the existing transfer belt or intermediate transfer belt.

### <Case of Providing a Diamond Fine Particle-Dispersed Resin or DLC on the Surface of a Rib of an Intermediate Transfer Belt>

Also, in the case of the color image forming apparatus shown in FIG. 2, in order to prevent misalignment at the time of color transfer, there may be the case of employing a structure as shown in FIG. 4A or FIG. 4B. A rib 42 made of rubber or an elastomer or the like is stuck on an end of the back face of the intermediate transfer belt 12. On the other hand, a guide groove 43 is provided in a conveyance roller 14a or 14b for suspending the intermediate transfer belt 12. There may be the case of employing a method of regulating meander of the intermediate transfer belt 12 by inserting the rib 42 into this guide groove 43.

In such case, by using a resin having a diamond fine particle dispersed therein or the like or applying DLC coating on the surface of the rib 42 of the intermediate transfer belt 12, the friction between the rib 42 and the conveyance roller 14a or 14b can be noticeably reduced. As a result, an unnatural “torsion force” is not generated; the misalignment accuracy is enhanced; and as a matter of course, the durability is enhanced.

As described previously, by dispersing a diamond fine particle in the surface layer of a transfer member such as a transfer belt or using a DLC layer, it is possible to make both high image quality transfer which is free from transfer unevenness or charge-up or the like and high durability compatible with each other. Also, in an intermediate transfer belt having an elastic layer, by applying the invention, it is possible to form the surface layer thin. Therefore, an effect of the elastic layer can be thoroughly exhibited; hollow defects at the time of transfer can be prevented; and high-image transfer and durability can be made compatible with each other.

Furthermore, of these effects of the diamond or DLC coat, as to those of high durability and low friction, for example, even an application to the surface of a rib 42 on the back face of the intermediate transfer belt 12 can contribute to realization of high image quality and high durability in a different sense.

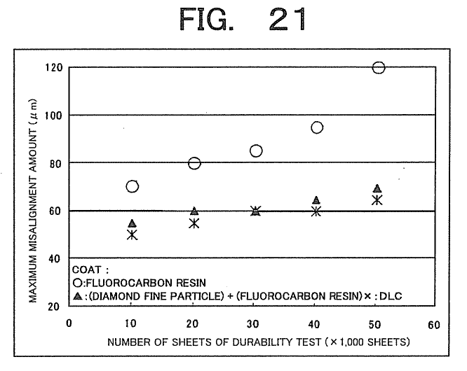

The misalignment accuracy was compared by using each of a fluorocarbon resin having a diamond fine particle dispersed therein, a DLC coat and a fluorocarbon resin not containing a diamond fine particle on the surface of the rib on the end of the back face of the intermediate transfer belt. FIG. 21 shows the results of comparative experiments. In FIG. 21, the abscissa represents the number of sheets of durability test (×1,000 sheets); and the ordinate represents a maximum amount of out of color alignment (μm). “◯” shows the case where a fluorocarbon resin coat is applied to the rib. “▴” shows the case where a fluorocarbon resin coat having a diamond fine particle dispersed therein is applied to the rib. “X” shows the case where a DLC coat is applied to the rib.

As to the amount of out of color alignment, Y (yellow), M (magenta), C (cyan) and K (black) lines were superimposed and printed in the horizontal scanning direction, an A3 image was printed, and a distance between the colors farthest from each other in nine points over the whole of the image in terms of misalignment in the horizontal scanning direction was measured. Five sheets of A3 paper were continuously printed; the first sheet and the fifth sheet were measured; and since the nine points were present in each of these sheets, the worst values in 18 points in total were employed and compared.

As shown in FIG. 21, in the case where only a fluorocarbon resin was coated on the rib, the misalignment was large from the initial stage, and as the number of sheets of durability test increased, the deterioration was observed. However, it is noted from the results shown in FIG. 21 that in the rib using a fluorocarbon resin having a diamond fine particle dispersed therein or a DLC coat, not only the misalignment is small from the initial stage, but also even when the durability test is carried out, the level of deterioration is low.

### <Summarization and Modifications>

In the light of the above, by dispersing the diamond fine particle on the surface layer of a transfer member of a transfer belt or applying a DLC layer as the surface layer, it is possible to make both transfer with a high image quality which is free from transfer unevenness or charge-up and high durability compatible with each other.

Also, in the intermediate transfer belt having an elastic layer, by applying the invention, the surface layer can be formed thin. Therefore, in the case of using an elastic layer, not only the effect of the elastic layer can be sufficiently exhibited, and the hollow defects at the time of transfer can be prevented, but also it is possible to make both transfer with a high image quality and high durability compatible with each other.

In the foregoing embodiments, the case of using a transfer belt or an intermediate transfer belt as a medium for transferring an image by a toner or the like has been described. However, the invention is also applicable to the case of using a transfer roller as a medium for transferring a visualized image. Here, the medium for transferring a toner image including such transfer belt and transfer roller is referred to as “transfer member”. This transfer member is required only to have a function to transfer a toner image onto a material to be transferred and may also take a shape other than a roller shape or a belt shape.

Also, in the foregoing embodiments, the case of developing an electrostatic latent image formed on a photoconductor by toner or the like and transferring the developed image onto paper by a transfer belt or via an intermediate transfer belt has been described. However, in the invention, a visualized image to be developed does not have to be a latent image formed on a photoconductor but may be in general an image carrier.

Obviously, many modifications and variations of this invention are possible in the light of the above teachings.

It is therefore to be understood that within the scope of the appended claims, this invention may be practiced otherwise than as specification.

What is claimed is:

1. A transfer member in an image forming apparatus for transferring a toner image obtained by developing an electrostatic latent image formed on an image carrier onto a material to be transferred, wherein the transfer member includes:
a base material; and
a surface layer formed on the base material and comprising a resin containing a diamond fine particle in the range of from about 0.01% to about 40%.

2. The transfer member according to claim 1, wherein the transfer member has a belt shape or a roller shape.

3. The transfer member according to claim 2, wherein the diamond fine particle has an average particle size of from about 5 nm to about 300 nm.

4. The transfer member according to claim 3, wherein a thickness for containing the diamond fine particle is in the range of from about 2 μm to about 7 μm.

5. The transfer member according to claim 4, wherein the resin is a fluorocarbon resin, and the base material is made of a polyimide resin.

6. The transfer member according to claim 4, wherein the resin is a fluorocarbon resin, and the base material is made of a rubber.

7. A transfer member in an image forming apparatus, which is a transfer belt in an image forming apparatus for transferring a toner image obtained by developing an electrostatic latent image formed on an image carrier onto a material to be transferred, wherein the transfer belt includes:
a base material;
an elastic layer formed on the base material and comprising an elastic material having a thickness of from about 30 μm to about 300 μm; and
a surface layer formed on the elastic layer and comprising a resin containing a diamond fine particle in the range of from about 0.01% to about 40%.

8. The transfer member according to claim 7, wherein the diamond fine particle has an average particle size of from about 5 nm to about 300 nm.

9. The transfer member according to claim 7, wherein the elastic layer is made of a urethane rubber or a silicon rubber.

10. The transfer member according to claim 9, wherein the resin is a fluorocarbon resin, and the base material is made of a polyimide resin.

11. The transfer member according to claim 9, wherein the resin is a fluorocarbon resin, and the base material is made of a rubber.

12. The transfer member according to claim 9, wherein the transfer member is in a belt shape and has a rib on an end thereof; and a resin layer having a diamond fine particle dispersed therein is formed in a contact site of a position regulating member on the surface of the rib.

13. A transfer member in an image forming apparatus for transferring a toner image obtained by developing an electrostatic latent image formed on an image carrier onto a material to be transferred, wherein the transfer member includes:
a base material; and
a surface layer formed on the base material and comprising diamond-like carbon.

14. The transfer member according to claim 13, wherein the transfer member has a belt shape or a roller shape.

15. The transfer member according to claim 14, wherein the surface layer has a thickness in the range of from about 2 μm to about 7 μm.

16. An image forming apparatus comprising
a rotatable photoconductive drum having a photoconductor on the surface thereof;
a charging section for charging the surface of the photoconductive drum;
an exposure section for irradiating light on the surface of the photoconductive drum charged by the charging section, thereby forming a latent image;
a development section for developing the latent image formed by the exposure section with a toner; and
a transfer member for transferring a toner image developed by the development section onto a material to be transferred, wherein
the transfer member includes
a base material having thereon a surface layer for temporarily holding on the surface thereof the toner image to be transferred onto the material to be transferred and comprising a resin containing a diamond fine particle in the range of from about 0.01% to about 40%.

17. The apparatus according to claim 16, wherein the transfer member has a belt shape or a roller shape.

18. The apparatus according to claim 17, wherein the diamond fine particle has an average particle size of from about 5 nm to about 300 nm.

19. The apparatus according to claim 18, wherein the transfer member is a transfer belt wound around conveyance rollers, and the transfer belt is provided with a cleaning member coming into contact with the transfer belt.

20. An image forming apparatus comprising
a rotatable photoconductive drum having a photoconductor on the surface thereof;
a charging section for charging the surface of the photoconductive drum;
an exposure section for irradiating light on the surface of the photoconductive drum charged by the charging section, thereby forming a latent image;
a development section for developing the latent image formed by the exposure section with a toner; and
a transfer member for transferring a toner image developed by the development section onto a material to be transferred, wherein
the transfer member includes
a base material having thereon a surface layer for temporarily holding on the surface thereof the toner image to be transferred onto the material to be transferred and comprising diamond-like carbon.

21. The apparatus according to claim 20, wherein the transfer member has a belt shape or a roller shape.

22. The apparatus according to claim 21, wherein the surface layer has a thickness in the range of from about 2 μm to about 7 μm.

23. The apparatus according to claim 22, wherein the transfer member is a transfer belt wound around conveyance rollers, and the transfer belt is provided with a cleaning member coming into contact with the transfer belt.
